(19) United States
(12) Patent Application Publication
(10) Pub. No.: US 2019/0366887 A1
(43) Pub. Date: Dec. 5, 2019

(54) VEHICLE STOWABLE SEAT STRUCTURE FLEXIBLE COVER

(71) Applicants: Raghdan Azzou, Commerce Township, MI (US); Thomas E. Drobot, Clarkston, MI (US); Michael J. Jarvis, Washington Township, MI (US); Meagan D. Atkinson, Detroit, MI (US); Richard E. Power, Oxford, MI (US); Tim Brush, West Bloomfield, MI (US); Whitney Jones, South Lyon, MI (US)

(72) Inventors: Raghdan Azzou, Commerce Township, MI (US); Thomas E. Drobot, Clarkston, MI (US); Michael J. Jarvis, Washington Township, MI (US); Meagan D. Atkinson, Detroit, MI (US); Richard E. Power, Oxford, MI (US); Tim Brush, West Bloomfield, MI (US); Whitney Jones, South Lyon, MI (US)

(21) Appl. No.: 16/541,820

(22) Filed: Aug. 15, 2019

Related U.S. Application Data
(63) Continuation of application No. 15/334,780, filed on Oct. 26, 2016, now abandoned.
(60) Provisional application No. 62/246,645, filed on Oct. 27, 2015.

(51) Int. Cl. B60N 2/30

(52) U.S. Cl. CPC B60N 2/3075

(57) ABSTRACT

A seat cover assembly, for a stowable vehicle seat having a seat structure extending from a seat bottom to at least a vehicle floor, includes a flexible cover assembly configured to couple to a lateral side of the vehicle seat and, in a concealing position, conceal at least a portion of the seat structure between the seat bottom and the vehicle floor when the seat is in a deployed position. The flexible cover assembly is configured to fold together as the vehicle seat is moved from the deployed position to a stowed position and unfold to the concealing position as the vehicle seat is moved from the stowed position to the deployed position.

### CROSS REFERENCE TO RELATED APPLICATION

This application is a Continuation of U.S. Ser. No. 15/334,780, filed Oct. 26, 2016, which claims the benefit of U.S. Provisional Ser. No. 62/246,645, filed Oct. 27, 2015.

### FIELD

The present application relates generally to vehicle seats and, more particularly, to a cover assembly for a stowable vehicle seat.

### BACKGROUND

In motor vehicles such as vans, mini-vans, and sport utility vehicles, passenger seating arrangements may be optionally stowable on-board the vehicle when not in use to provide additional or improved storage capacity for carrying cargo. However, some portions of the vehicle seat structure may be visible and exposed when the seat is in the design seating or deployed position, which may affect perceived quality, subject the seat structure to a potential for increased wear, and/or potentially allow objects to enter an associated vehicle seat storage compartment. Accordingly, while stowable seat assemblies have generally worked for their intended purpose, it is desirable to provide further improvement in the relevant art.

### SUMMARY

According to one exemplary aspect of the invention, a seat cover assembly is provided for a stowable vehicle seat having a seat structure extending from a seat bottom of the vehicle seat to at least a vehicle floor. In an exemplary implementation, the seat cover assembly includes a flexible cover assembly configured to couple to a lateral side of the vehicle seat and, in a concealing position, conceal at least a portion of the seat structure between the seat bottom and the vehicle floor when the seat is in a deployed position. The flexible cover assembly is configured to fold together as the vehicle seat is moved from the deployed position to a stowed position and unfold to the concealing position when the vehicle seat is moved from the stowed position to the deployed position.

According to another exemplary aspect of the invention, a vehicle seat is provided. The vehicle seat includes, in an exemplary implementation, a seat back, a seat bottom, a seat structure including at least one front leg and at least one rear leg, the seat structure extending from the seat bottom to at least a vehicle floor, and a seat cover assembly configured to conceal at least a portion of the seat structure between the seat bottom and the vehicle floor. The seat cover assembly includes a flexible cover assembly coupled to the seat structure about a lateral side of the vehicle seat, and the flexible cover assembly is configured to fold together from a concealing position as the vehicle seat is moved from a deployed position to a stowed position and unfold to the concealing position when the seat is moved from the stowed position to the deployed position.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a perspective view of an exemplary vehicle seat and seat cover assembly in accordance with the principles of the present disclosure;

FIG. 1A is another perspective view of the vehicle seat shown in FIG. 1 and associated with a storage tub or compartment in accordance with the principles of the present disclosure;

FIG. 2 is a perspective view of the flexible cover assemblies shown in FIG. 1 in accordance with the principles of the present disclosure;

FIG. 3 is a perspective view of the flexible cover assemblies shown in FIG. 2 with exemplary front leg and rear leg cover assemblies in accordance with the principles of the present disclosure; and

FIG. 4 is an exploded view of the front leg and rear leg cover assemblies shown in FIG. 3 in accordance with the principles of the present disclosure.

### DETAILED DESCRIPTION

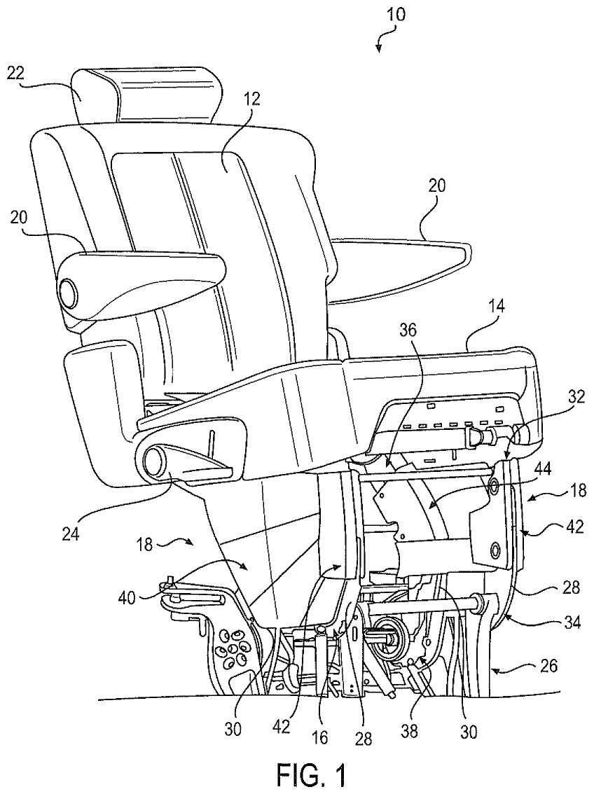

With initial reference to FIGS. 1 and 1A, an exemplary vehicle seat 10 according to various aspects of the present disclosure is illustrated. The vehicle seat 10 is configured to couple to a vehicle frame and/or compartment floor 11 and, in the exemplary implementation, the vehicle seat 10 is configured as a second-row stowable seat that folds and/or tumbles into a seat tub or storage compartment 13. For example, the vehicle seat 10 may be stowed into storage compartment 13 to provide a flat load floor vehicle configuration. When the vehicle seat is stowed, a passageway can be provided to a rearward area of the vehicle for access to a cargo area and/or a third row of seating (not shown). In addition to being stowable, the vehicle seat 10 may also include ingress/egress and fore/aft adjustment assemblies. However, the vehicle seat 10 is not limited to second-row seating and may be used in various other vehicles or seating arrangements.

In one exemplary implementation, the vehicle seat 10 generally includes a seat back 12, a seat bottom 14, seat structure 16, and a pair of exemplary flexible seat cover assemblies 18.

Seat back 12 includes a pair of arm rests 20 and a head rest 22 each coupled to the seat back 12 in any suitable manner. The seat bottom 14 may include a release mechanism 24 to facilitate collapsing the seat back 12 to a collapsed position or to release the vehicle seat 10 from various other positions.

The seat structure 16 includes an articulation arrangement 26, and a pair of front legs 28 and rear legs 30 operatively associated with the seat bottom 14 and articulation arrangement 26. The articulation arrangement 26 may be configured to assist in articulating and lowering the vehicle seat 10 toward a stowed position and articulating and raising seat 10 from the stowed position toward a deployed or seating position.

A first or upper end 32 of each leg of the front legs 28 is pivotably coupled to seat bottom 14, and a second or lower end 34 of legs 28 can be operatively coupled to the articulation arrangement 26 for selective movement with and/or relative thereto. A first or upper end 36 of rear legs 30 is pivotably coupled to seat bottom 14, and a second or lower end 38 of rear legs 30 can include a latch arrangement (not shown) for releasably coupling rear legs 30 to a vehicle load floor 15 or a similar frame or structural member.

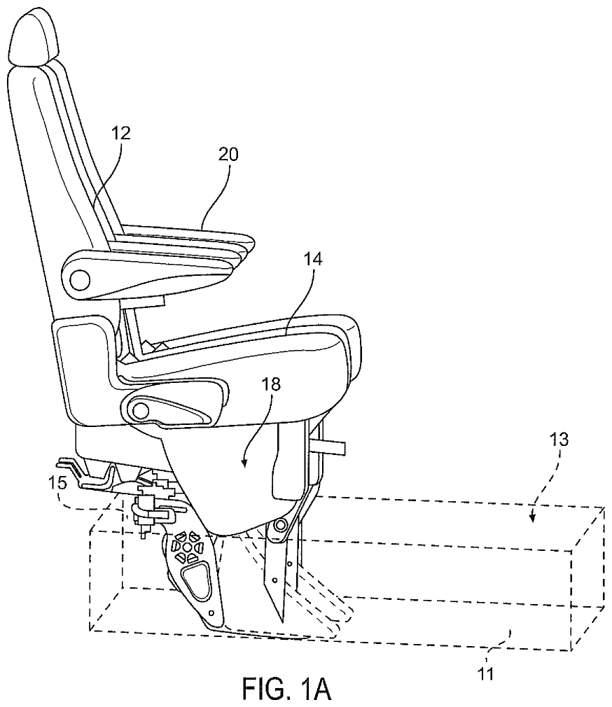

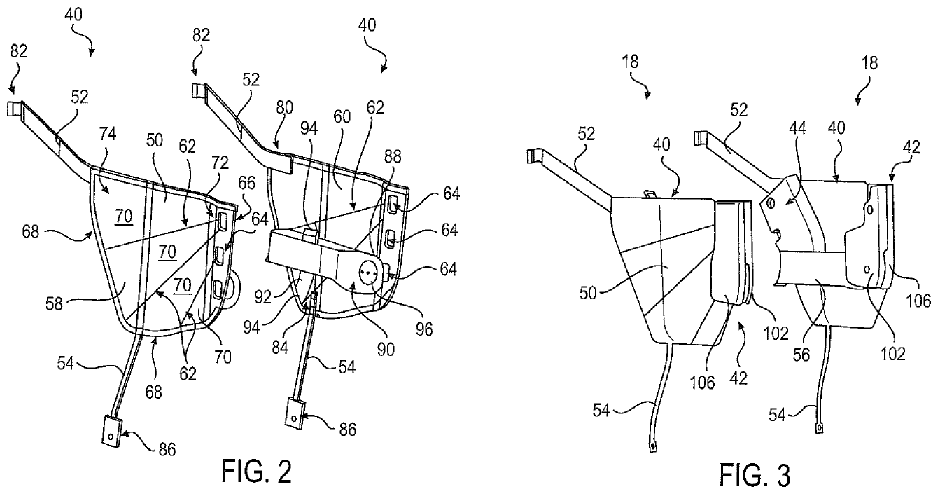

With additional reference to FIGS. 2 and 3, the flexible seat cover assemblies 18 are illustrated in further detail. Seat cover assemblies 18 are configured to couple to each lateral side of the vehicle seat 10 and cover or conceal at least a portion of seat structure 16 between seat bottom 14 and load floor 15 of the vehicle. Load floor 15 includes, for example, the floor of the vehicle that supports occupants as well as a movable portion of the load floor 15 for selectively providing access to the storage compartment 13. Each seat cover assembly 18 generally includes a flexible cover assembly 40, a front leg cover assembly 42, and a rear leg cover assembly 44. The flexible cover assembly 40 is configured to cooperate with the movement or articulator of the seat from the stowed position to the deployed position, as discussed in greater detail below.

In one exemplary implementation, flexible cover assembly 40 is formed of a flexible material and includes a main body portion 50, a first cable or strap 52, a second cable or strap 54, and a third cable or strap 56. Examples of the flexible material include fabric, flexible plastics and/or flexible soft trim materials associated with vehicle seats. Main body portion 50 includes an outer face 58, an inner face 60, a plurality of material fold lines 62, and a plurality of apertures 64 formed therein. Outer face 58 is configured to face away from the vehicle seat structure 16, and inner face 60 is configured to face toward the vehicle seat structure 16.

As shown in FIG. 2, fold lines 62 are formed in the main body portion 50 and generally extend across main body portion 50 from a first edge 66 to a second edge 68. Fold lines 62 are configured to enable main body portion 50 to fold over upon itself as the vehicle seat 10 is moved from the deployed position (FIG. 1) to the stowed position (not shown), thereby preventing bunching of main body portion 50 or interference with the vehicle seat structure 16 during seat movement.

In one implementation, fold lines 62 are formed by a stitching across main body portion 50. However, fold lines 62 may be formed by any suitable process that enables flexible cover assembly 40 to function as described herein. For example, fold lines 62 may be formed by sewing a join seam.

As illustrated in FIG. 2, fold lines 62 may be generally oriented in a fanned configuration to define a plurality of body sections 70 that increase in height from a first end 72 to a second end 74. As such, body sections 70 neatly fold upon each other as the seat 10 is moved from the deployed position to the stowed position. However, fold lines 62 may be oriented in any suitable configuration that enables flexible cover assembly 40 to function as described herein. Further, although main body portion 50 is illustrated with three fold lines 62 defining four body sections 70, main body portion 50 may include any suitable number of body sections such as three or five.

As such, in the deployed position, flexible cover assembly 40 is oriented perpendicular to or generally perpendicular to the vehicle load floor 15. In the stowed position, flexible cover assembly 40 is folded over upon itself such that body sections 70 are oriented parallel to or generally parallel to the vehicle load floor 11.

The plurality of apertures 64 of main body portion 50 are formed proximate main body portion first edge 66 and are configured to provide for attachment of the front leg cover assemblies 42 to flexible cover assembly 40 and front legs 28, as is described herein in more detail.

First strap 52 includes a first end 80 and a second end 82. The first end 80 is coupled to main body portion 50 proximate the second edge 68, and the second end 82 is configured to couple to an upper portion of the seat structure 16 and/or to seat bottom 14. In one implementation, first strap 52 is fabricated from elastic strap. Accordingly, first strap 52 is configured to secure flexible cover assembly 40 to the vehicle seat 10.

Second strap 54 includes a first end 84 and a second end 86. The first end 84 is coupled to main body portion 50 proximate the second edge 68, and the second end 86 is configured to couple to a lower portion of the seat structure 16. In one implementation, second strap 54 is fabricated from an elastic strap. Accordingly, second strap 54 is configured to secure flexible cover assembly 40 to the vehicle seat 10.

Third strap 56 includes a first end 88 and a second end 90. The first end 88 is coupled to main body portion 50 proximate the first edge 66 and apertures 64. At least a portion of first end 88 may be held in place against inner face 60 by a holding strap 92 (FIG. 2), which has each of its ends 94 coupled to inner face 60. Second end 90 includes an aperture 96 configured to provide for attachment of the front leg cover assemblies 42 to flexible cover assembly 40 and front legs 28. Second end 90 is configured to couple to one front leg cover assembly 42, as described herein in more detail. In one implementation, third strap 56 is fabricated from an elastic webbing strap. As illustrated in FIG. 1, third strap 56 is configured to wrap around rear leg 30, rear leg cover assembly 44, and at least a portion of front leg 28. As such, third strap 56 is configured to secure flexible cover assembly 40 to the vehicle seat 10.

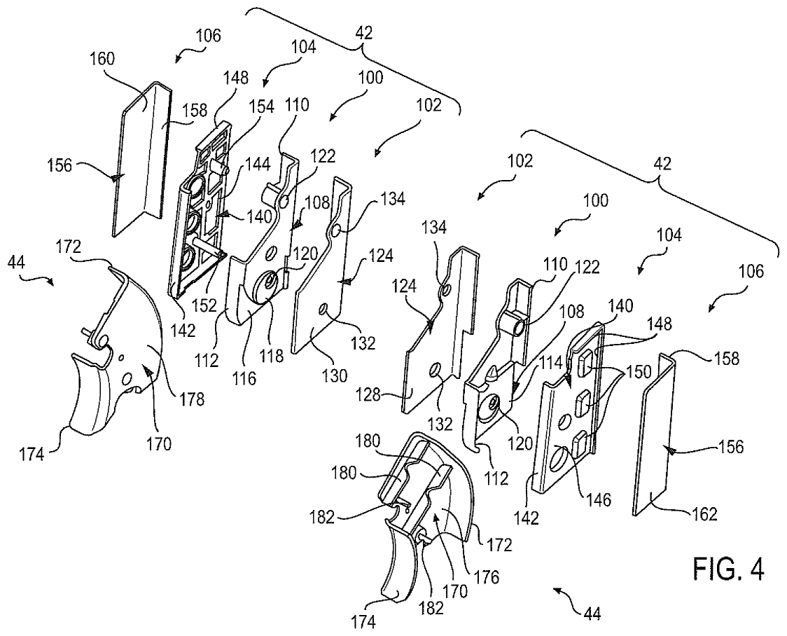

FIG. 4 provides further illustration of front leg cover assemblies 42 and rear leg cover assemblies 44, which respectively provide rigid or semi-rigid structure to the front and rear of each seat cover assembly 18. In the example implementation, each front leg cover assembly 42 includes an inner leg substrate 100, an inner leg bezel 102, an outer leg substrate 104, and an outer leg bezel 106.

Inner leg substrate 100 includes a body portion 108, a front flange 110, and a rear flange 112. Body portion 108 includes an inner face 114, an outer face 116, a strap projection 118, a first aperture 120, and a second aperture 122. Inner face 114 is configured to be disposed against and coupled to an inner side of front leg 28. Front flange 110 extends from body portion 108 and is configured to be disposed against a forward edge of front leg 28, and rear flange 112 extends from body portion 108 and is configured to be disposed against a rear edge of front leg 28. Strap projection 118 extends from outer face 116 and is configured to be disposed within third strap aperture 96 to facilitate securing third strap second end 90 between inner leg substrate 100 and inner leg bezel 102.

Inner leg bezel 102 includes a body portion 124 and a front flange 126. Body portion 124 includes an inner face 128, an outer face 130, a first aperture 132, and a second aperture 134. Inner face 128 is configured to be disposed against inner leg substrate outer face 116, and front flange 126 is configured to be disposed against inner leg substrate front flange 110. Apertures 132 and 134 are configured to be respectively aligned with apertures 120 and 122 for receiving a fastener therethrough. As such, inner leg substrate 100 and inner leg bezel 102 are secured to front leg 28 with substrate 100 inboard of bezel 102.

Outer leg substrate 104 includes a body portion 140 and a rear flange 142. Body portion 140 includes an inner face 144, an outer face 146, a raised lip or edge 148, a plurality of projections 150, a first fastener tube 152, and a second fastener tube 154. Inner face 144 is configured to be disposed against an outer side of front leg 28, and rear flange 142 extends from body portion 140 and is configured to be disposed against a rear edge of front leg 28 and/or rear flange 112.

Raised edge 148 extends from outer face 146 and is configured to facilitate alignment of flexible cover assembly 40 by contacting first edge 66 against raised edge 148. Projections 150 extend from outer face 146 and are configured to be disposed within flexible cover apertures 64 to facilitate securing flexible cover assembly 40 between outer leg substrate 104 and outer leg bezel 106. Fastener tubes 152, 154 extend from inner face 144 and are configured to respectively align with apertures 120 and 122 for receiving a fastener therethrough.

Outer leg bezel 106 includes a body portion 156 and a front flange 158. Body portion 156 includes an inner face 160 and an outer face 162. Inner face 160 is configured to be disposed against and coupled to outer leg substrate 104, for example by welding. Thus, flexible cover 40 is secured between outer leg substrate 104 and outer leg bezel 106. Front flange 158 is configured to be disposed against a forward edge of front leg 28 and/or against outer leg substrate 104. As such, outer leg substrate 104 and outer leg bezel 106 are secured to front leg 28 with substrate 104 inboard of bezel 106.

In one example implementation, each rear leg cover assembly 44 includes a body portion 170, a front flange 172, and a rear flange 174. Body portion 170 includes an inner face 176, an outer face 178, structural ribs 180, and a plurality of locator features or pins 182. Inner face 176 is configured to be disposed against rear leg 30, front flange 172 extends from body portion 170 and is configured to be disposed against a front edge of rear leg 30, and rear flange 174 extends from body portion 170 and is configured to be disposed against a rear edge of rear leg 30. Pins 182 extend from body portion inner face 176 and are configured to assist coupling rear leg cover assembly 44 to rear leg 30.

A method of assembling seat cover assemblies 18 includes providing vehicle seat 10. Inner leg substrate 100 and outer leg substrate 104 are arranged on either side of front leg 28 and coupled thereto, for example, by inserting fasteners (not shown) through corresponding tubes 152, 154 and apertures 120, 122. Flexible cover main body portion 50 is then arranged on outer leg substrate 104 such that projections 150 are inserted into main body portion apertures 64. Outer leg bezel 106 is subsequently coupled to outer leg substrate 104 to secure flexible cover main body portion 50 to front leg 28.

Rear leg cover assembly 44 is then coupled to rear leg 30, and first strap second end 82 and second strap second end 86 are coupled to seat structure 16. Third strap 56 is wrapped around rear leg 30 and rear leg cover assembly 44 and back toward front leg 28. Third strap second end 90 is arranged on inner leg substrate 100 such that strap projection 118 is inserted into aperture 96. Inner leg bezel 102 is subsequently coupled to inner leg substrate 100 to further secure flexible cover assembly 40 to front leg. As such, flexible cover assembly 40 is secured to the vehicle seat 10.

Described herein are systems and methods for covering and protecting a vehicle seat structure. The systems include one or more seat cover assemblies having a flexible cover assembly, a front leg cover assembly, and a rear leg cover assembly. The flexible cover assembly is secured to the vehicle seat to at least partially cover the vehicle seat structure, such as the structure between the seat bottom and load floor 15. The flexible cover assembly includes body sections that are configured to fold when the vehicle seat is moved from a deployed position to a stowed position. In one exemplary implementation, the flexible cover assembly, via its formation from flexible material and the body sections and fold lines, is completely flexible and configured to fold upon itself during stowage and return to its original shape to a concealing position, as shown with the seat in the deployed positions in FIGS. 1 and 1A. Thus the seat cover assembly is configured to cover or conceal the seat structure to improve the visual aesthetics of the seat, protect against exposure and wear to the seat structure, and prevent objects from entering the seat storage compartment.

It should be understood that the mixing and matching of features, elements and/or functions between various examples may be expressly contemplated herein so that one skilled in the art would appreciate from the present teachings that features, elements and/or functions of one example may be incorporated into another example as appropriate, unless described otherwise above.

What is claimed is:

1. A seat cover assembly for a stowable vehicle seat having a seat structure extending from a seat bottom of the vehicle seat to at least a vehicle floor, the seat cover assembly comprising:
a flexible cover assembly configured to couple to a lateral side of the vehicle seat and, in a concealing position, conceal at least a portion of the seat structure extending between the seat bottom and the vehicle floor when the vehicle seat is in a deployed position;
wherein the flexible cover assembly is configured to fold together as the vehicle seat is moved from the deployed position to a stowed position and unfold to the concealing position as the vehicle seat is moved from the stowed position to the deployed position;
wherein the flexible cover assembly includes a main body portion having a plurality of fold lines formed therein defining a plurality of body sections, and wherein the body sections fold over upon each other as the vehicle seat is moved from the deployed position to the stowed position; and
wherein the fold lines are formed by a stitching in the main body portion.

2. A seat cover assembly for a stowable vehicle seat having a seat structure extending from a seat bottom of the vehicle seat to at least a vehicle floor, the seat assembly comprising:
a flexible cover assembly configured to couple to a lateral side of the vehicle seat and, in a concealing position, conceal at least a portion of the seat structure extending between the seat bottom and the vehicle floor when the vehicle seat is in a deployed position; and
a rear leg cover assembly configured to couple to a rear leg of the vehicle seat, and to receive at least a portion of the flexible cover assembly;
wherein the flexible cover assembly is configured to fold together as the vehicle seat is moved from the deployed position to a stowed position and unfold to the concealing position as the vehicle seat is moved from the stowed position to the deployed position.

3. The seat cover assembly of claim 2, wherein the rear leg cover assembly includes a body portion, a front flange and a rear flange extending from the body portion, and a plurality of structural ribs extending from the body portion.

4. The seat cover assembly of claim 3, further comprising a front leg cover assembly configured to couple to a front leg of the vehicle seat and integrated with at least a portion of the flexible cover assembly to secure the flexible cover assembly to the front leg.

5. The seat cover assembly of claim 4, wherein the front leg cover assembly comprises:
an inner leg substrate configured to couple to an inner surface of the front leg;
an inner leg bezel configured to couple to the inner leg substrate;
an outer leg substrate configured to couple to an outer surface of the front leg; and
an outer leg bezel configured to couple to the outer leg substrate,
wherein a first portion of the flexible cover assembly is configured to be disposed between the inner leg substrate and the inner leg bezel, and a second portion of the flexible cover assembly is configured to be disposed between the outer leg substrate and the outer leg bezel.

6. The seat cover assembly of claim 5, wherein the outer leg substrate includes a plurality of projections, and the flexible cover assembly includes a plurality of apertures configured to receive the plurality of projections.

7. The seat cover assembly of claim 5, wherein the inner leg substrate includes a projection, and the flexible cover assembly includes a strap having an aperture configured to receive the projection.

8. The seat cover assembly of claim 1, wherein the flexible cover assembly further includes:
a first strap configured to couple to an upper portion of the seat structure proximate the seat bottom; and
a second strap configured to couple to a bottom portion the seat structure proximate the vehicle floor.

9. The seat cover assembly of claim 8, wherein the flexible cover assembly further includes a third strap configured to wrap around a rear leg of the vehicle seat.

10. A vehicle seat, comprising:
a seat back;
a seat bottom;
a seat structure including at least one front leg and at least one rear leg, the seat structure extending from the seat bottom to at least a vehicle floor; and
a seat cover assembly configured to conceal at least a portion of the seat structure between the seat bottom and the vehicle floor, the seat cover assembly including a flexible cover assembly coupled to the seat structure about a lateral side of the seat, the flexible cover assembly configured to fold together from a concealing position as the vehicle seat is moved from a deployed position to a stowed position and unfold to the concealing position as the seat is moved from the stowed position to the deployed position;
wherein the flexible cover assembly comprises:
a main body portion having a plurality of fold lines formed therein defining a plurality of body sections, wherein the body sections fold over upon each other as the vehicle seat is moved from the deployed position to the stowed position;
a first strap coupled between the main body portion and an upper portion of the seat structure to secure the flexible cover assembly thereto;
a second strap coupled between the main body portion and a lower portion of the seat structure to further secure the flexible cover assembly thereto; and
a third strap wrapped around the rear leg and coupled to the front leg to further secure the flexible cover assembly thereto.

11. The vehicle seat of claim 9, wherein the seat cover assembly further comprises:
a rear leg cover assembly coupled to the rear leg, wherein the third strap is wrapped around the rear leg cover assembly; and
a front leg cover assembly coupled to the front leg and integrated with at least a portion of the flexible cover assembly, the front leg cover assembly comprising:
an inner leg substrate configured to couple to an inner surface of the front leg;
an inner leg bezel configured to couple to the inner leg substrate;
an outer leg substrate configured to couple to an outer surface of the front leg; and
an outer leg bezel configured to couple to the outer leg substrate,
wherein at least a portion of the third strap is disposed between the inner leg substrate and the inner leg bezel, and at least a portion of the main body portion is disposed between the outer leg substrate and the outer leg bezel.
